(19) United States
(12) Patent Application Publication
(10) Pub. No.: US 2018/0253986 A1
(43) Pub. Date: Sep. 6, 2018

(54) ELECTRONIC FLASH CARD METHODS AND SYSTEMS

(71) Applicant: FLIP FLASH CARDS PTY LTD, Brisbane, Queensland (AU)

(72) Inventor: Kim Charles HALLIDAY, Brisbane (AU)

(21) Appl. No.: 15/754,058

(22) PCT Filed: Oct. 5, 2016
(86) PCT No.: PCT/AU2016/050934

§ 371 Date: Feb. 21, 2018

(30) Foreign Application Priority Data
Oct. 6, 2015 (AU) 2015904052

(51) Int. Cl. G09B 5/06; G09B 7/02; G10L 13/02; G06F 3/01; G06F 3/147; G06F 3/0481; G06Q 30/06

(52) U.S. Cl. CPC G09B 5/062; G09B 7/02; G10L 13/02; G06F 3/017; G06F 2200/1637; G06F 3/04812; G06Q 30/0601; G09G 2354/00; G06F 3/147

(57) ABSTRACT

An electronic flash card user device and an electronic flash card method enable a user to “flip” electronic flash cards in a manner that is intuitive to the user and easy to perform. The method comprises: presenting, on a user device, a first side of an electronic flash card to a user, the first side of the flash card containing first information; detecting movement of the user device; and presenting, on the user device, a second side of a flash card to the user, the second side of the flash card containing second information; wherein the electronic flash card is configured to switch from the first side to the second side based upon the detected movement.

### TECHNICAL FIELD

The present invention relates to electronic flash cards. In particular, although not exclusively, the invention relates to playback of electronic flash cards, and a marketplace for acquisition of electronic flash cards.

### BACKGROUND ART

Flash cards are well known to help improve memory and the learning. Traditional flash cards are generally palm sized cardboard or paper sheets with information thereon, which are used to aid memorisation through repetition.

Information is generally printed on both sides of the flash card, and may take the form of a question on one side of the card and an answer thereto on the other side. However, many other forms may be used, including a term on one side with the definition thereof on the other side, and may include a combination of images and text.

Flash cards were traditionally produced by the person using the flash cards, albeit often in rudimentary form. However flash cards may also be mass produced in relation to common topics.

A problem with flash cards of the prior art is that they are generally time consuming and difficult to make. As such, individuals may be reluctant to spend time making cards for themselves only.

More recently, digital (or electronic) flash cards have become more popular. In such case a user is able to view the flash cards on a computing device, and flip or navigate between cards using buttons. A problem with digital flash cards of the prior art is that they are generally difficult to make, and do not have the same impact as traditional flash cards.

Accordingly, there is a need for improved electronic flash card methods.

It will be clearly understood that, if a prior art publication is referred to herein, this reference does not constitute an admission that the publication forms part of the common general knowledge in the art in Australia or in any other country.

### SUMMARY OF INVENTION

The present invention is directed to electronic flash card methods and systems, which may at least partially overcome at least one of the abovementioned disadvantages or provide the consumer with a useful or commercial choice.

With the foregoing in view, the present invention in one form, resides broadly in an electronic flash card method comprising:

presenting, on a user device, a first side of a flash card to a user, the first side of the flash card containing first information;

detecting movement of the user device; and

presenting, on the user device, a second side of a flash card to the user, the second side of the flash card containing second information;

wherein the electronic flash card is configured to switch from the first side to the second side based upon the detected movement.

Advantageously, the electronic flash card method enables a user to “flip” the flash card in a manner that is intuitive to the user and easy to perform.

Preferably, the first information includes a question, and the second information includes an answer to the question.

Preferably, the movement comprises a tilting of the user device. Alternatively, the movement may comprise translational movement, rotational movement or shaking of the user device.

Preferably, the user device is a smartphone or tablet computer.

Preferably, the method further comprises:

converting at least part of the first information to speech; and

presenting, on the user device, the speech to the user.

Preferably, text of the first information is automatically retrieved and converted to speech, and wherein the speech is played back automatically.

Preferably, the speech is played on a speaker of the user device.

Preferably, the method further comprises providing an online marketplace for electronic flash cards to the user, by:

receiving, from the user, a flash card indicator; and

presenting, to the user, a plurality of flash cards according to the indicator.

Preferably, the indicator comprises a flash card category. Alternatively, the indicator comprises a flash card type.

The method may further comprise: receiving payment from the user, and providing the flash card to the user in response thereto.

Preferably, at least a portion of the payment is provided to a user associated with provision of the flash card.

The method may further comprise: providing a code to the user, and providing electronic flash card to a user in response to receiving the code.

Preferably, the first side of the flash card contains a link, wherein the link is selectable by the user and comprises a link to content that is external to the user device.

The link may comprise a Uniform Resource Locator (URL).

Preferably, the link is a link to external media, which is configured to be played back in the flash card. Alternatively, the link may be a link to an online marketplace, for display external to the flash card, and for purchase of further flash cards. In such case, the link may be a link to a page of the online marketplace, associated with a publisher of the flash card.

The method may comprise a dementia recognition method, comprising a familiarity component (e.g. familiar music or video), and a memory trigger component, wherein the familiarity component is configured to be presented prior to the memory trigger component, to increase recognition of the memory trigger component by the patient.

In another form, the invention resides broadly in an electronic flash card method comprising:

presenting, on a user device, a first side of a flash card to a user, the first side of the flash card containing first information; and

converting at least part of the first information to speech; and

presenting, on the user device, the speech to the user.

Advantageously, the method enables users to use electronic flash cards without needing to focus on a display screen. This is particularly relevant when the user is multitasking, such as driving a vehicle or performing another task.

Text of the first information may be automatically retrieved and converted to speech.

The speech may be played on a speaker of the user device.

The speech may be played back automatically.

In yet another form, the invention resides broadly in a method of providing an online marketplace for electronic flash cards to a user, the method comprising:

receiving, from a user, a flash card indicator; and

presenting, to the user, a plurality of flash cards according to the indicator.

Advantageously, flash cards are presented to the user according to the indicator, which may enable a customised marketplace to be provided.

The indicator may comprise a flash card category, such as new, popular, or free flash cards.

The indicator may comprise a flash card type, such as educational, business, games.

The method may include receiving payment from the user, and providing the flash cards to the user in response thereto. The method may further comprise, providing at least a portion of the payment to a user associated with provision of the flash card.

The method may comprise: providing a code to the user, and providing a set of flash cards to the user according to the code.

In yet another form, the present invention resides in an electronic flash card method comprising:

presenting, on a user device, a first side of a flash card to a user, the first side of the flash card containing first information and a first link;

wherein the first link is selectable by the user and links external to the user device.

Advantageously, the method enables generators of the flash cards to, for example, link back to other flash cards that they have generated.

Preferably, the first link comprises a Uniform Resource Locator (URL).

Preferably, the first link is a link to an online marketplace for purchase of further flash cards.

Preferably, the first link is a link to a page of the online marketplace, associated with a publisher of the flash card.

In another form, the invention resides broadly in an method for use with dementia patients for improving recall of memories, the method comprising:

presenting, on a user device, a first side of a flash card to a user, the first side of the flash card containing music or video that is familiar to the patient; and

presenting, on the user device, a second side of a flash card to the user, the second side of the flash card containing second information in the form of a memory trigger, wherein the first side is provided to improving recall of memories relating to the memory trigger.

The memory trigger may comprise an image and a name of a family member of the patient. The name may be presented to the patient as speech.

In yet another form, the invention resides in a system including:

a processor; and

a memory coupled to the processor, the memory including instruction code executable by the processor for implementing any of the above methods.

Any of the features described herein can be combined in any combination with any one or more of the other features described herein within the scope of the invention.

The reference to any prior art in this specification is not, and should not be taken as an acknowledgement or any form of suggestion that the prior art forms part of the common general knowledge.

### BRIEF DESCRIPTION OF DRAWINGS

Various embodiments of the invention will be described with reference to the following drawings, in which:

FIG. 1 illustrates an electronic flash card system, according to an embodiment of the present invention;

FIG. 2 illustrates screenshot of a flash card generation screen of the electronic flash card system of FIG. 1, according to an embodiment of the present invention;

FIG. 3a illustrates playback of a flash card on a user device at a first time point;

FIG. 3b illustrates playback of a flash card on a user device at a second time point;

FIG. 3c illustrates playback of a flash card on a user device at a third time point;

FIG. 4 illustrates a user device for playing back an electronic flash card, according to an embodiment of the present invention;

FIG. 5 illustrates a screenshot of a flash cards store, according to an embodiment of the present invention; and

FIG. 6 illustrates a screenshot of a flash card, according to an embodiment of the present invention.

Preferred features, embodiments and variations of the invention may be discerned from the following Detailed Description which provides sufficient information for those skilled in the art to perform the invention. The Detailed Description is not to be regarded as limiting the scope of the preceding Summary of the Invention in any way.

### DESCRIPTION OF EMBODIMENTS

Embodiments of the present invention enable a content creator to create sets of electronic flash cards, and share the electronic flash cards with other viewers. As an illustrative example, teachers may create sets of flash cards specifically for a student or class, and share them on an online marketplace.

The flash cards may be used virtually anywhere, for example on a phone or portable computing device, and motion based interaction can be used to virtually flip the cards, as described below. Similarly, text to speech may enable a user to utilise electronic flash cards without being required to focus on a digital display screen.

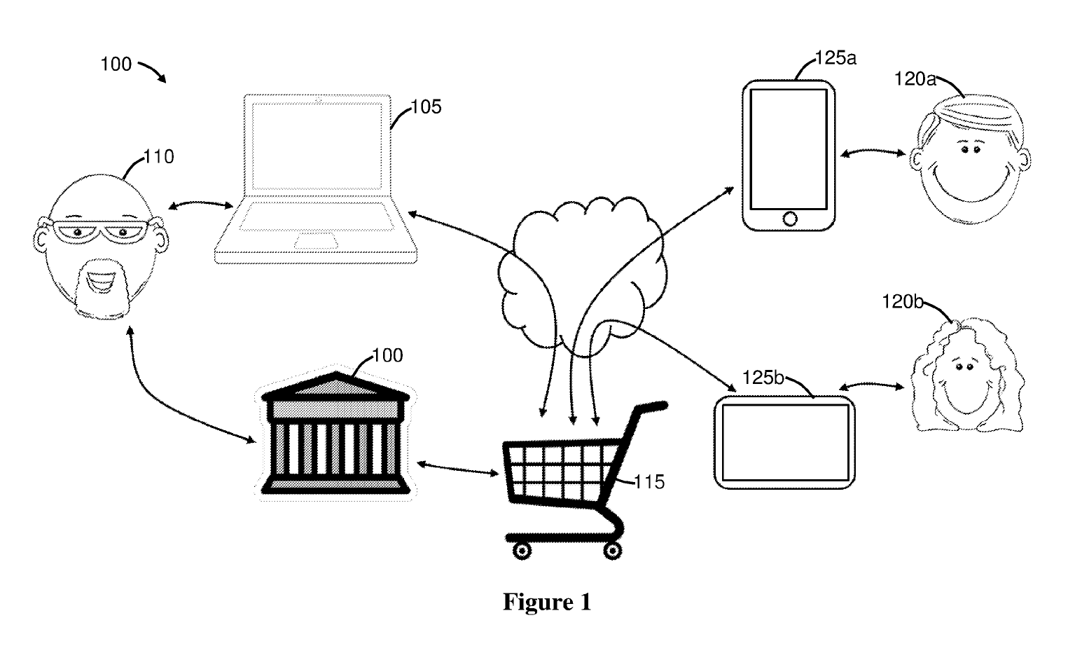

FIG. 1 illustrates an electronic flash card system 100, according to an embodiment of the present invention.

The system 100 includes a flash card generator computer 105, in which a flash card generator 110 is able to generate flash cards. In particular, the flash card generator 110 is a person, such as a teacher, that generates flash cards for use by others.

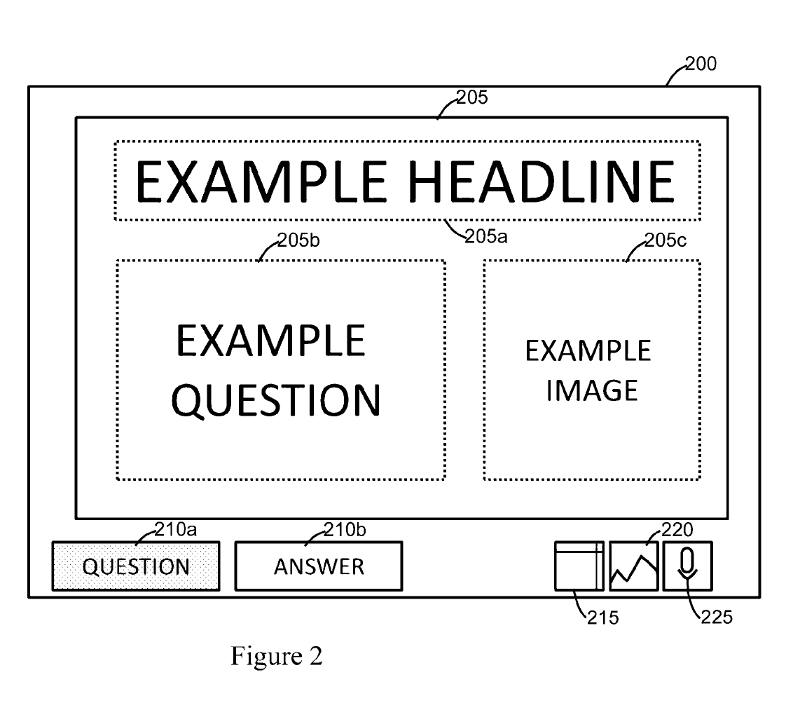

Generation of the flash cards is described with reference to FIG. 2 below, but generally includes entering questions and answers to be presented on the flash cards. Upon completion of a set of flash cards, they are uploaded to a store 115, which enables purchase of the flash cards by other users.

In particular, a first user 120a and a second user 120b may access the store 115 on respective flash card playback device 125a, 125b. The flash card playback devices 125a, 125b may be purpose built devices, but are advantageously general purpose portable computing devices, such as smartphones or tablet computers.

As discussed in further detail below, the store 115 includes an interface which enables the users 125a, 125b to input a flash card indicator which influences which flash cards presented to the user. Examples of flash card indicators include explicit indicators, such as a flash card category, such as new, popular, or free flash cards, or a flash card type, such as educational, business, games. Alternatively, the indicator may be implicit, and may comprise a personalised flash card indicator that is associated with the user 125a, 125b.

Upon selection of a flash card set by a user 120a, 120b, payment is generally made to the store 115, for example by credit card or a third party payment service, after which the flash card set is downloaded to the device 125a, 125b for playback to the user 120a, 120b.

The store 115 is coupled to a bank 130, which may assist in processing the payment from the user 120a, 120b, but also in transferring all or part of the payment to the flash card generator 110. As such, the flash card generator 110 may compensated for generating the flash card set, which can motivate flash card generators 110 to create flash cards.

According to certain embodiments, the flash card generator 110 may specify a price he or she is willing to sell each flash card set for. In such case, the system is able to accommodate various levels of flip flash card sets, from the simple (and thus inexpensive) to the complex and/or niche sets, which may be more expensive.

FIG. 2 illustrates screenshot 200 of a flash card generation screen of the electronic flash card system 100, according to an embodiment of the present invention.

The screen includes a flash card editor element 205, which enables the user to edit “sides” of a flash card in a What You See Is What You Get (WYSIWYG) style interface. In particular, the flash card editor element 205 includes a headline element 205a, in which the user may enter text as a headline of the flash card, a question element 205b, in which the user may enter text as a question of the flash card, and an image element 205c, in which a user may enter an image of the flash card.

The flash card generation screen includes a question button 210a, and an answer button 210b. The question and answer buttons 210a, 210b enable a user to toggle between question and answer sides of the flash card, upon which the flash card editor element 205 is updated accordingly.

The flash card generation screen further includes a template button 215, an image button 220 and a sound recording button 225.

The template button 215 enables the user to select a template which is applied to the flash card and thus the editor element 205. The template may define a relative layout of the headline element 205a, the question element 205b, and the image element 205c, and/or other aspects of the flash card, such as background colour or background image, font, and the like.

The image button 220 enables the user to insert an image onto the flash card. In such case, the image may be retrieved from an image database, which may include a plurality of general purpose images. Alternatively, the image may be retrieved from the user's device, and be captured by the user, or have previously been captured or downloaded by the user.

Finally, the sound recording button 225 enables a user to record audio that is associated with the flash card. The audio may be a reading of the card by the designer (e.g. the flash card generator), additional information in relation to the card, or any other audio. Similarly, the audio may also be pre-recorded and uploaded by the user.

In some embodiments, the user is able to define how the audio is played back. For example, the user may choose between playing the audio upon presentation of the particular side of the flash card, upon flipping of the flash card, or after a set time delay.

By embedding recorded audio into a flash card, the creator is able to provide a flash card that does not require the user to look at the flash card. In particular, the recorded audio may read the contents of the flash card, enabling the user to use the flash cards while driving, cooking, or performing other tasks where concentration on the screen is not possible.

According to certain embodiments, the user may be able to embed video in the flash card. The video may be inserted onto the card in a similar way to the images, as described above, and initially presented to the user as an image. The video may then be played in place of the image, either automatically or based upon user interaction.

As described in further detail below, the video may be third party content, which is downloaded and displayed directly from the third party. As an illustrative example, the video may comprise a YouTube video which is configured to be downloaded and played back on the device as needed (rather than being saved on the device).

In some embodiments, the user is able to create and/or insert symbols into flash cards. This is particularly advantageous when symbols are new to the system, or when it may not be clear how symbols are pronounced. As an illustrative example, one symbol may be kg (kilogram). In such case, it may be desirable to include the symbol ‘kg’ on the flash card (i.e. visually), but have the symbol read as ‘kilogram’.

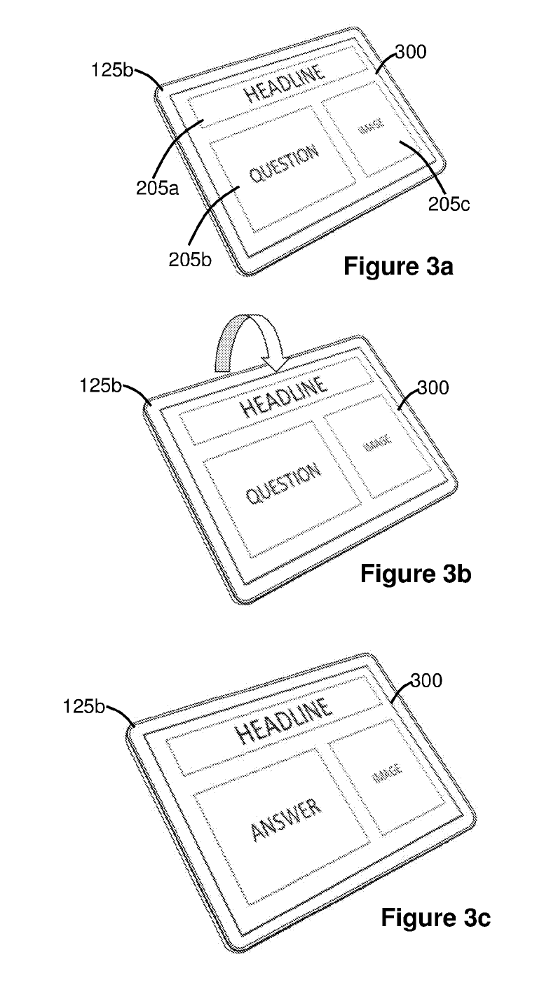

FIG. 3a, FIG. 3b and FIG. 3c illustrate playback of a flash card on a user device 125b, according to an embodiment of the present invention.

Initially, as illustrated in FIG. 3a, the question side of a flash card 300 is displayed on the user device. As discussed above, the question side of the flash card 300 includes a headline, question and graphics.

Initially, the user reads the question, just as he or she would with a traditional flash card, and then, as illustrated in FIG. 3b, tilts the user device to “flip” the flash card.

The flip is a virtual flip that typically corresponds to the flipping of a traditional flash card in that the screen transitions from the question side of the card to the answer side, as illustrated in FIG. 3c. However, more generally, each flash card may have more than two “sides”, and the virtual flip may correspond to a transition between one screen or side and another.

The skilled addressee will readily appreciate that any suitable motion of the device may be used to flip the card, including shaking the device or rotating the device. Similarly, the user may alternatively flip the card by pressing the screen, swiping, pushing a button, using a voice command, or any other suitable user interaction. This is particularly advantageous when the device is held in a holder, and it is not appropriate to move the device.

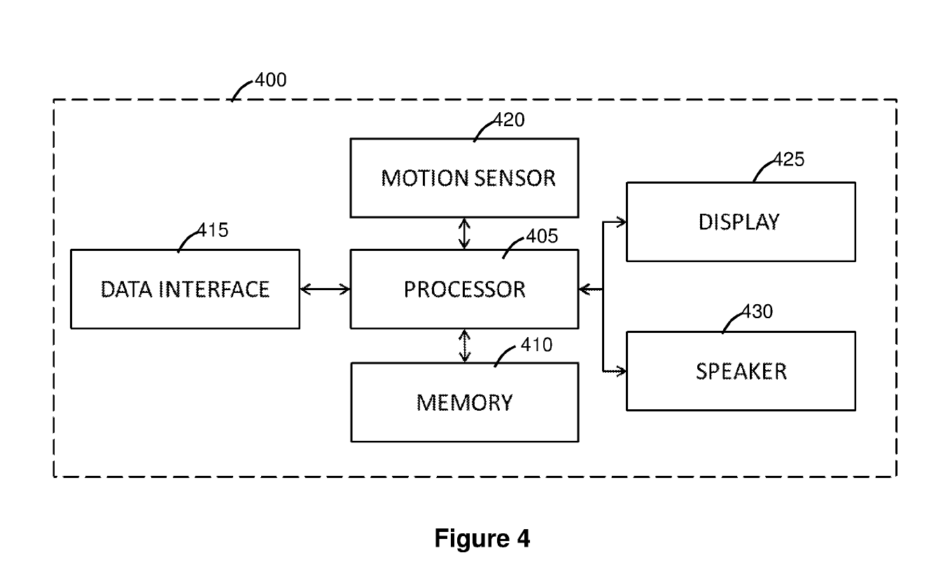

FIG. 4 illustrates a user device 400 for playing back an electronic flash card, according to an embodiment of the present invention. The user device may be similar or identical to the user device 125a, 125b of the system 100.

The use device 400 includes a processor 405, a memory 410, a data interface 415, a motion sensor 420, a display 425 and a speaker 430.

The memory 410 is coupled to the processor 405, and includes instruction code for, among other things, interpreting flash cards, decoding audio, images, and the like, and operating system functionality.

The data interface 415 is also coupled to the processor, and enables the user device 400 to communicate with external systems, such as the store 115. In such way, the user device 400 can be used together with flash cards generated by others, as discussed above.

The motion sensor 420 is coupled to the processor and is configured to detect movement of the device 400. The motion sensor 420 may be configured to detect translational movements, rotational movements, tilting, or any other motion or movement of the device 400 such as shaking of the device 400. The motion of the device 400 may then be used to control flipping of flash cards, as discussed above.

The display 425 and a speaker 430 are also coupled to the processor and are configure to display flash cards and play sounds respectively. In particular, a flash card is typically displayed on the display 425, and a sound associated with the flash card may be simultaneously presented to the user.

The processor may be further configured to retrieve text form the flash card, and convert the text to speech. The speech is converted from the text using known text to speech methods, and may include detecting a language associated with the text.

The speech is then played back to the user, either automatically or in response to a command, and enables the user to utilise the flash cards even when unable to view a display screen. Example scenarios include listening to flash cards when operating a vehicle.

According to certain embodiments, the flash card generation screen enables the user to enter text specifically for playback to the user. This may, for example, be in the form of metadata associated with the flash card, or a setting associated with text. As an illustrative example, some systems may interpret white text on a white background as text to be read to the user.

This enables the user generating the card to customise the text that is read to the user. That is particularly useful if the flash card includes more text than shall be read to the user, or if the flash card contains graphics, of which a description is read to the user.

The device 400 may include additional elements to enable other functionality, such as telephonic functionality. In such case, the device 400 may comprise a smart phone, a tablet computer, or any other suitable multifunction device.

In some embodiments, the user is able to define how the flash cards are played back. For example, the user may set a user specified delay (countdown), upon which the card transitions from the first side to the second side, or between cards. In some cases, the user is able to provide a “set and forget” setting to the flash cards, enabling the user to use the device without any further input from the user.

In certain cases, the countdown may be overridden by the user. For example, when the user already is familiar with a card and wishes to skip to the next card. This is particularly advantageous in avoiding frustration when the user has more difficulty memorising some cards than others.

Various other settings may also be controlled when automatically playing back flash cards, such as in the set and forget setting described above. For example, the user may select to playback one side only (e.g. questions), loop through the flash cards, either randomly, in sequence, or otherwise, or choose a voice (such as a male or female voice) for reading of the flash cards.

In certain embodiments, the user device 400 may be configured to play back the electronic flash card on a separate device, such as a television, a radio or the like. This is convenient when several users are using flash cards together, for example, of simply when the user wishes to take advantage of a large screen device in their proximity. Similarly, the device 400 may be configured to play back audio wirelessly, e.g. via Bluetooth, on one or more speakers.

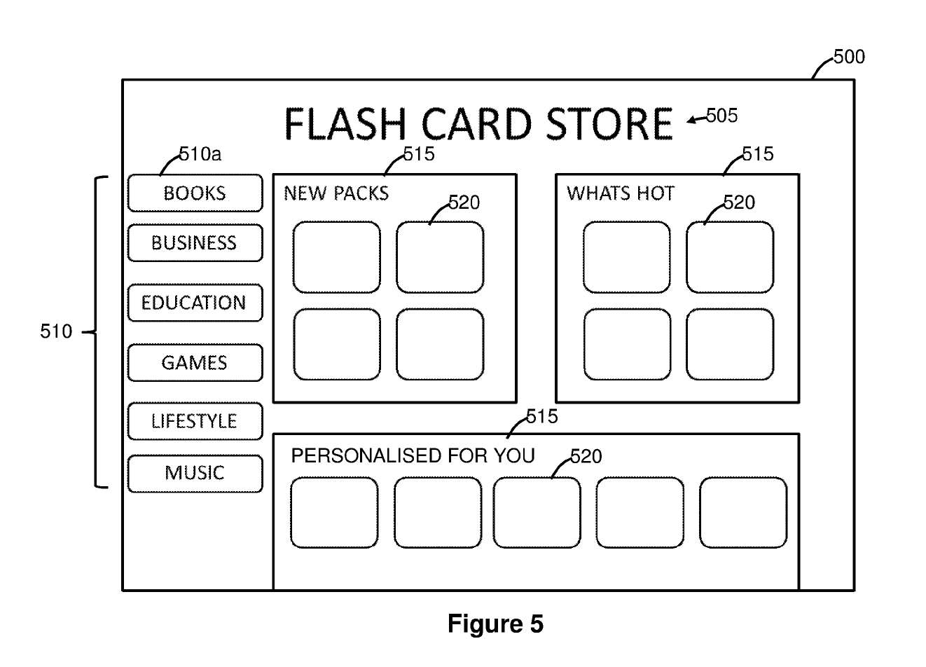

FIG. 5 illustrates a screenshot 500 of a flash cards store, according to an embodiment of the present invention. The flash cards store may be similar or identical to the flash cards store 115 of FIG. 1. The flash cards store enables users, such as the users 120a, 120b, to purchase flash cards which have been generated by others.

The flash cards store is an online store that comprises a website having a header 505, a menu 510 comprising a plurality of menu items 510a, and a plurality of grouping elements 515, each containing a plurality of flash card link elements 520. The user may purchase a flash card set by selecting a corresponding link element 520.

Each grouping element 515 is associated with a category, to assist the user in navigating among the flash card link elements 520. Examples of categories include new flash cards, popular flash cards, free flash cards, personalised recommendations and the like.

The grouping elements 515 may be configured to display a subset of the flash card link elements 520 associated with the group, for example due to space constraints. In such case, the grouping elements 515 maybe selectable, upon which all of the link elements 520 associated with the group are displayed.

The menu items 510a are each associated with a type of flash card, such as business related, educational, games and the like. Upon selection of a menu item 510a, the flash card link elements 520 are updated according to the selected menu item.

As an illustrative example, a menu item 510a may exist for education, and a submenu may exist for various types of education, such as education associated with different qualifications, such as electrical qualifications, or school based education, such as year 11 and 12 mathematics. As such, the user is able to navigate among menu items 510a and select appropriate flash cards as needed.

The skilled addressee will readily appreciate that the above described menu system comprises one example of receiving a flash card indicator from the user. Other examples include receiving implicit flash card indicators from the user, including demographics of the user, or any other suitable data.

According to certain embodiments, the flash cards may be associated with a code. In such case, a developer may efficiently distribute cards to a plurality of users by providing codes to the users, which enable them to retrieve the flash cards.

The code may be single use, and associated with payment of the flash cards, or multi-use, and thus separate to any payment means. Several different codes may be provided to different groups of users to track different marketing policies and usage statistics.

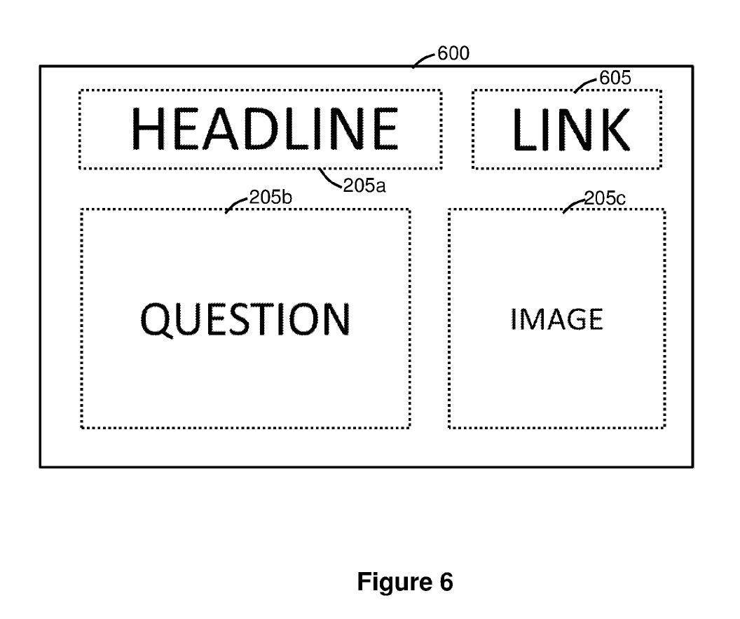

FIG. 6 illustrates a screenshot 600 of a flash card, according to an embodiment of the present invention.

The flash card includes a headline element 205a, a question element 205b, and an image element 205c, similar to the flash cards discussed earlier. However, the flash card further includes a link element 605.

The link element 605 may be in the form of an image, text, or a combination thereof, and provides a link that is selectable by the user. The link generally comprises a Uniform Resource Locator (URL), and may link to an online marketplace for purchase of further flash cards, or a page of the online marketplace, associated with a publisher of the flash card.

As an illustrative example, the link element 605 may comprise a company logo, with which a link to a company website is associated. As such, the link element may help promote brand awareness associated with the flash cards, while providing a link to the company website to enable purchase of other flash cards.

This enables the creator of the flash cards to provide a link back to a page of his or her choosing, which can be used as advertising and enable the purchase of additional cards.

According to certain embodiments, the flash card includes a link element for embedding external content into the flash card. The external content may comprise a video, or other type of media, located on a third party server. As an illustrative example, the external content may comprise a YouTube video (of YouTube, LLC, San Bruno, Calif.), which is played back inside the flash card.

Advantageously, the flash cards may be used for dementia and Alzheimer's patients. It is understood that familiar music may open up memories that otherwise appear lost. As such, flash cards may be generated where familiar music or video is played to the user, followed by a memory trigger (e.g. image and speech). By playing music initially, the flash card is able to increase recognition with the memory trigger.

As an illustrative example, the music may be music of the dementia and Alzheimer's patient's youth, and the memory trigger may comprise an image of a family member of the patient together with speech of the family member's name.

According to certain embodiments, a playlist of familiar songs or familiar videos may be generated that is customised to the patient. This may increase recognition by the patient, which may in turn increase memory.

As external content may be provided in the flash cards, any suitable content which the patient associates with may be provided. For example, music, poetry, a family member talking, televisions shows, parts of movies, melodies, images, graphics or symbols, or any combination thereof, may be provided, as desired by the user.

According to certain embodiments, the flash cards are copy protected by linking the cards to specific user devices. This may be performed using a digital rights management (DRM) system, or any other suitable means, and can be used to prevent unauthorised distribution of the flash cards.

In such case, at purchase of the flash cards, an identifier of the user device may be obtained. The flash cards may then be encoded according to the identifier, such that the flash card can only be played on the user device, and then provided to the user.

The encoding may comprise encryption. In particular, the encoding may comprise asymmetric encryption, wherein the identifier is a public key. In such case, a private key may be associated with the user device to enable the encoded flash card to be decoded. The private key is generally stored securely in a flash card player installed on the user device to prevent unauthorised access to the private key.

The encoding may alternatively or additionally verified using online authentication methods. In particular, the encoding may be verified at least once each time the flash card is selected by the user.

According to certain embodiments, a specialised flash card player is provided for users. The flash card player may separate the content of the flash cards, and how they are presented, providing a simple way of generating cards, and consistent playback of cards.

According to certain embodiments, a free flash card player may be provided including advertising, and a paid flash card player may be provided without advertising. As such, flash card creators can ensure that their cards can be viewed by users without needing to purchase any further software.

Similarly, a combined flash card creator/viewer may be provided including, typically at a higher cost than the paid flash card player (which is a player only), to enable users to both create and play flash cards.

According to certain embodiments, the player may include print functionality, to enable the user to print a hard copy of the flash cards.

In some embodiments, a third party printing service is provided, where the user is able to order hard copies through the player, for delivery to the user. In such case, the system (or individual player) may regulate how many copies may be printed (e.g. based upon settings of the content creator).

In other embodiments, the user is able to print hard copies him or her self. In such case, the player may be configured to generate content suitable for printing, in portable document format (PDF), or any other format suitable for printing.

While the flash cards have been primarily illustrated with reference to a question/answer scenario, any suitable content may be provided on the flash cards. For example, flash cards may be generated for gym training, wherein the content of the card indicates to the user a number of repetitions of a particular activity, and may automatically switch between various activities. Similarly, the flash card may include a term on one side with the definition thereof on the other side.

Similarly, much of the above has generally been described in relation to a single flash card. However, flash cards are generally provided in packs containing a plurality of flash cards. In such case, the user may set the player to play the pack in sequential or random mode.

Similarly, the user may select the speed in which cards are displayed, and thus cause playback speed to be increased or decreased.

Finally, the flash cards may be configured to be repeated a particular number of times, until the user exits the application, or played once.

In the present specification and claims (if any), the word ‘comprising’ and its derivatives including ‘comprises’ and ‘comprise’ include each of the stated integers but does not exclude the inclusion of one or more further integers.

Reference throughout this specification to ‘one embodiment’ or ‘an embodiment’ means that a particular feature, structure, or characteristic described in connection with the embodiment is included in at least one embodiment of the present invention. Thus, the appearance of the phrases ‘in one embodiment’ or ‘in an embodiment’ in various places throughout this specification are not necessarily all referring to the same embodiment. Furthermore, the particular features, structures, or characteristics may be combined in any suitable manner in one or more combinations.

In compliance with the statute, the invention has been described in language more or less specific to structural or methodical features. It is to be understood that the invention is not limited to specific features shown or described since the means herein described comprises preferred forms of putting the invention into effect. The invention is, therefore, claimed in any of its forms or modifications within the proper scope of the appended claims (if any) appropriately interpreted by those skilled in the art.

1. An electronic flash card method comprising:
presenting, on a user device, a first side of an electronic flash card to a user, the first side of the flash card containing first information;
detecting movement of the user device; and
presenting, on the user device, a second side of a flash card to the user, the second side of the flash card containing second information;
wherein the electronic flash card is configured to switch from the first side to the second side based upon the detected movement.

2. The method of claim 1, wherein the first information includes a question, and the second information includes an answer to the question.

3. The method of claim 1, wherein the movement comprises a tilting of the user device.

4. The method of claim 1, wherein the movement comprises one or more of a translational movement, a rotational movement or shaking of the user device.

5. The method of claim 1, wherein the user device is a smartphone or tablet computer.

6. The method of claim 1, further comprising:
converting at least part of the first information to speech; and
presenting, on the user device, the speech to the user.

7. The method of claim 6, wherein text of the first information is automatically retrieved and converted to speech, and wherein the speech is played back automatically.

8. The method of claim 6, wherein the speech is played on a speaker of the user device.

9. The method of claim 1, further comprising providing an online marketplace for electronic flash cards to the user, by:
receiving, from the user, a flash card indicator; and
presenting, to the user, a plurality of flash cards according to the indicator.

10. The method of claim 9, wherein the indicator comprises a flash card category.

11. The method of claim 9, wherein the indicator comprises a flash card type.

12. The method of claim 1, further comprising: receiving payment from the user, and providing the flash card to the user in response thereto.

13. The method of claim 12, wherein at least a portion of the payment is provided to a user associated with provision of the flash card.

14. The method of claim 1, further comprising: providing a code to the user, and providing electronic flash card to a user in response to receiving the code.

15. The method of claim 1, wherein the first side of the flash card contains a link, wherein the link is selectable by the user and comprises a link to content that is external to the user device.

16. The method of claim 1, wherein the link comprises a Uniform Resource Locator (URL).

17. The method of claim 16, wherein the link is a link to external media, which is configured to be played back in the flash card.

18. The method of claim 16, wherein the link is a link to an online marketplace, for display external to the flash card, and for purchase of further flash cards.

19. The method of claim 18, wherein the link is a link to a page of the online marketplace, associated with a publisher of the flash card.

20. An electronic flash card user device including:
a processor; and
a memory coupled to the processor, the memory including instruction code executable by the processor for:
presenting, on the user device, a first side of an electronic flash card to a user, the first side of the flash card containing first information;
detecting movement of the user device; and
presenting, on the user device, a second side of a flash card to the user, the second side of the flash card containing second information;
wherein the electronic flash card is configured to switch from the first side to the second side based upon the detected movement.
